(19) United States
(12) Patent Application Publication
(10) Pub. No.: US 2007/0135091 A1
(43) Pub. Date: Jun. 14, 2007

(54) Electronic equipment with call key lock and program for providing the same

(76) Inventor: Tomas Karl-Axel Wassingbo, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/297,764

(22) Filed: Dec. 8, 2005

(51) Int. Cl. H04M 3/16

(52) U.S. Cl. 455/410

(57) ABSTRACT

An electronic equipment which includes one or more keys that enable a user to control operation of the electronic equipment; call circuitry that enables the electronic equipment to establish a call with a called/calling device; and key lock circuitry which, upon detecting that the call circuitry has established a call, automatically disables at least one of the one or more keys.

### TECHNICAL FIELD OF THE INVENTION

The present invention relates generally to electronic equipment for engaging in voice communications, and more particularly to electronic equipment that avoids unintended disruption or ending of such voice communications.

### DESCRIPTION OF THE RELATED ART

Electronic equipment that provide for voice communication, such as mobile phones, personal digital assistants, mobile terminals, etc., are becoming increasingly popular. Such various forms of electronic equipment typically include numerous keys in the form of a keypad and/or touchscreen that allow for operation by a user. For example, a mobile phone typically includes a keypad having numerical keys and function keys. A user will typically enter a telephone number via the numerical keys, and initiate a call by activating a designated “send/call” key. In order to end a call, the user will typically activate a designated “call end” key which functions to “hang up” the call. Various other keys may be provided, such as a web browser launch key, mute key, etc.

During an ongoing call, a user may very easily end (hang up) or disrupt the call by inadvertently pressing one or more of the keys. For example, the user may accidentally end a call by inadvertently pressing the “call end” key. Alternatively, the user may disrupt the call by accidentally pressing a “mute” key. Such accidental pressing of the keys can occur, for example, as a result of the user pressing the keys of the phone against his or her cheek. As another example, during ‘hands free” operation the user may inadvertently set an object such as a purse or the like on the mobile phone and thereby unintentionally activate the “call end” key, “mute” key, or the like. Similarly, if the user keeps the mobile phone in his or her pocket during “hands free” operation, the user may unintentionally activate the keys of the mobile phone by simple movement.

In the past, key lock features have been provided in mobile phones. However, such key lock features typically have been for avoiding inadvertent activation of the mobile phone, such as the unintended initiation of potentially expensive calls. Such key lock features did not protect against inadvertent ending of a call. Recently published U.S. Patent Application Publication No. US 2005/0079896 A1 describes a mobile phone having a key lock feature intended to protect against inadvertent ending of a call. However, such mobile phone requires that a user activate the lock during each call in order to utilize its benefits. Moreover, the lock causes all of the keys to be locked, including those the user otherwise may prefer to remain active.

### SUMMARY

In view of the aforementioned shortcomings associated with existing electronic equipment subject to inadvertent disruption or ending of a call, there is a strong need in the art for electronic equipment which does not suffer from such drawbacks. More particularly, there is a strong need in the art for electronic equipment which prevents a user from unintentionally ending or disrupting a call by locking keys on its keyboard. Moreover, there is a strong need in the art for such electronic equipment which does not require the user to activate the lock during each call. Still further, there is a strong need in the art for such electronic equipment which enables one or more keys to be locked while one or more other keys remain active.

According to an aspect of the invention, an electronic equipment is provided which includes one or more keys which enable a user to control operation of the electronic equipment; call circuitry that enables the electronic equipment to establish a call with a called/calling device; and key lock circuitry which, upon detecting that the call circuitry has established a call, automatically disables at least one of the one or more keys.

According to another aspect, the at least one of the one or more keys comprises a key which, if not disabled, would at least one of disrupt or end the established call if activated.

According to another aspect, the at least one of the one or more keys comprises a call end key.

According to another aspect, the at least one of the one or more keys comprises a key which, if not disabled, would cause an audible disruption if activated.

According to another aspect, the at least one of the one or more keys comprises an audio mute key.

According to another aspect, the key lock circuitry automatically disables the at least one key which would at least one of disrupt or end the established call, but does not disable one or more other keys.

According to another aspect, the one or more other keys comprise at least one of a volume key, web browse launch key, camera key or data input key.

According to another aspect, the one or more keys are embodied in at least one of a keypad or a touchscreen.

According to another aspect, the user may selectively cause the key lock circuitry to reenable the at least one of the one or more keys during the established call.

According to another aspect, the user may selectively cause the key lock circuitry to reenable the at least one of the one or more keys by pressing a predefined key among the one or more keys for at least a predetermined time.

According to another aspect, the predefined key is a call end key.

According to another aspect, the key lock circuitry detects when the call has been ended other than by the user, and upon detecting that the call has been ended other than by the user automatically reenables the at least one of the one or more keys.

According to another aspect, the electronic equipment is a mobile phone.

According to another aspect, the key lock circuitry may be selectively enabled by the user via a user interface.

According to another aspect, the user may selectively enable the key lock circuitry among an always on mode, always off mode, and hands-free mode.

According to still another aspect, a program stored on a machine readable medium is provided. The program is suitable for use in an electronic equipment having one or more keys which enable a user to control operation of the electronic equipment and call circuitry that enables the electronic equipment to establish a call with a called/calling device. When the program is loaded in memory in the electronic equipment and executed, the program causes the electronic equipment, upon detecting that a call has been established, to disable automatically at least one of the one or more keys.

According to another aspect, the at least one of the one or more keys comprises a key which, if not disabled, would at least one of disrupt or end the established call if activated.

According to another aspect, the at least one of the one or more keys comprises a call end key.

According to another aspect, the at least one of the one or more keys comprises a key which, if not disabled, would cause an audible disruption if activated.

According to another aspect, the at least one of the one or more keys comprises an audio mute key.

According to another aspect, the program causes the electronic equipment to detect when the call has been ended other than by the user, and upon detecting that the call has been ended other than by the user, automatically to reenable the at least one of the one or more keys.

According to another aspect, the program is designed for the electronic equipment to be a mobile phone.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a schematic view of a mobile phone as an exemplary electronic equipment in accordance with an embodiment of the present invention;

FIG. 2 is a schematic block diagram of the relevant portions of the mobile phone of FIG. 1 in accordance with an embodiment of the present invention;

FIGS. 3A, 3B, 3C and 3D illustrate exemplary graphical user interface screen displays on the mobile phone of FIG. 1 in accordance with an embodiment of the present invention; and

FIG. 4 is a flowchart representing the relevant operation of the mobile phone of FIG. 1 in accordance with an embodiment of the present invention.

### DETAILED DESCRIPTION OF EMBODIMENTS

The present invention will now be described with reference to the drawings, wherein like reference numerals are used to refer to like elements throughout.

The term “electronic equipment” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like. In the present application, the invention is described primarily in the context of a mobile phone. However, it will be appreciated that the invention is not intended to be limited to a mobile phone and can be any type of electronic equipment.

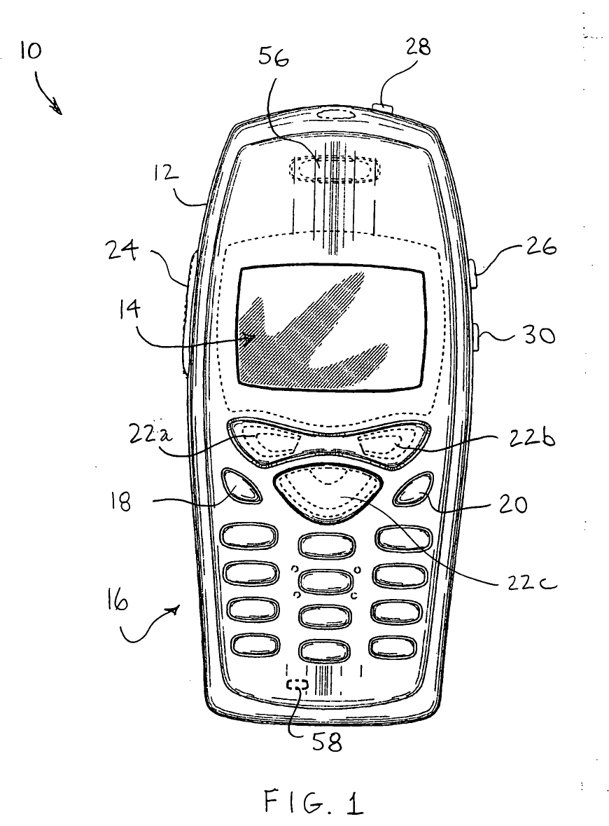

Referring initially to FIG. 1, an electronic equipment 10 is shown in accordance with the present invention. In the exemplary embodiment described herein, the electronic equipment is a mobile phone 10. The mobile phone 10 is shown as having a “brick” or “block” design type housing 12, but it will be appreciated that other type housings such as clamshell or slide-type housings may be utilized without departing from the scope of the invention.

The mobile phone 10 includes a display 14 and keypad 16. As is conventional, the display 14 displays information to a user such as operating state, time, phone numbers, contact information, various navigational menus, etc., which enable the user to utilize the various feature of the mobile phone 10. Similarly, the keypad 16 may be conventional in that it provides for a variety of user input operations. For example, the keypad 16 typically includes alphanumeric keys for allowing entry of alphanumeric information such as telephone numbers, phone lists, contact information, notes, etc. In addition, the keypad 16 typically includes special function keys such as a “call send” key 18 for initiating or answering a call, and a “call end” key 20 for ending, or “hanging up” a call. Special function keys may also include menu navigation keys 22a, 22b and 22c, for example, for navigating through a menu displayed on the display 14 to select different phone functions, profiles, settings, etc., as is conventional. Other keys included in the keypad 16 may include a volume key 24, audio mute key 26, on/off power key 28, web browser launch key 30, camera key, etc.

In the particular embodiment of FIG. 1, the mobile phone 10 includes the display 14 and separate keypad 16. In an alternative embodiment, the display 14 may comprise a touchscreen which itself includes one or more keys. In yet another embodiment, the display 14 may comprise a touchscreen that includes all or substantially all of the keys used to operate the phone 10 so as to include a very limited keypad 16 or no keypad 16 at all. As will be appreciated, the particular form and function of the keys included in the keypad 16 or touchscreen/display 14 are not germane to the invention in its broadest sense.

As will become more apparent in view of the following description, the mobile phone 10 overcomes the aforementioned shortcomings associated with existing electronic equipment. Specifically, the mobile phone 10 includes conventional call circuitry that enables the phone to establish a call with a called/calling device, typically another mobile phone or landline phone. However, the called/calling device need not be another phone, but may be some other device such as an Internet web server, etc. In addition, the mobile phone 10 includes key lock circuitry that detects when the call circuitry has established a call or a call has ended. Upon detecting that the call circuitry has established a call, the key lock circuitry in the mobile phone 10 automatically disables one of the one or more keys which otherwise would render the mobile phone 10 subject to inadvertent disruption or ending of the call. More particularly, the mobile phone 10 automatically prevents a user from unintentionally ending or disrupting a call by locking keys on its keypad upon a call being established. The mobile phone 10 does not require the user to activate the lock during each call. Furthermore, the mobile phone 10 may be configured such that one or more keys (e.g., “call end” key 20, “mute” key 26, on/off power key 28, etc.) to be locked while one or more other keys remain active (e.g., alphanumeric keys, volume key 24, web browser launch key 30, camera key, etc.).

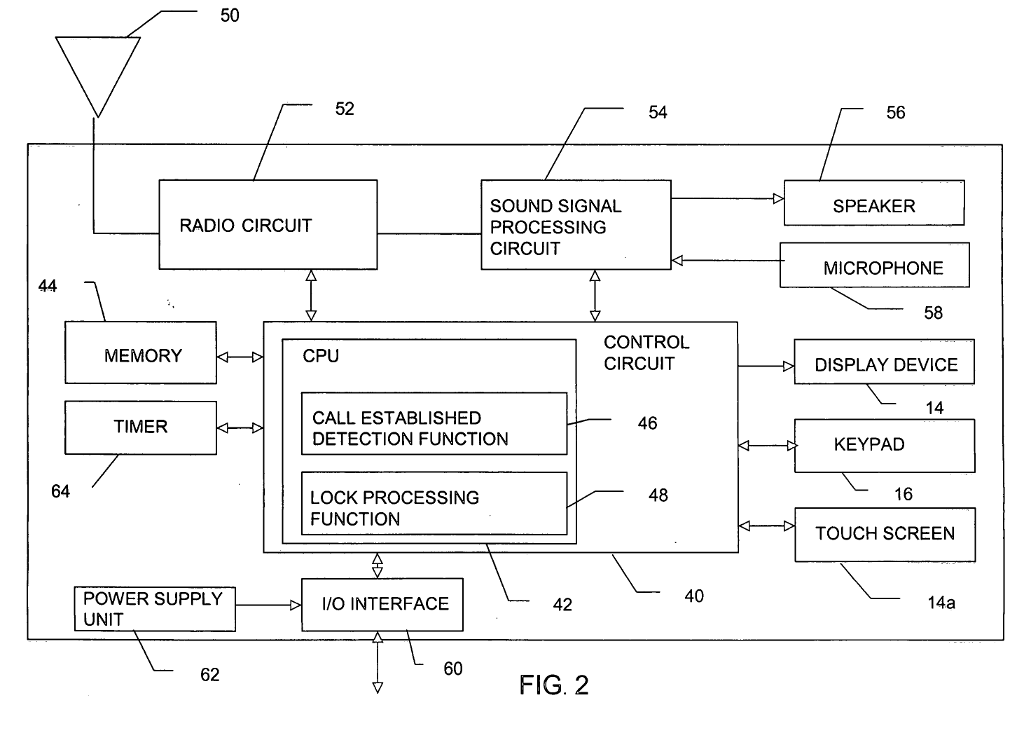

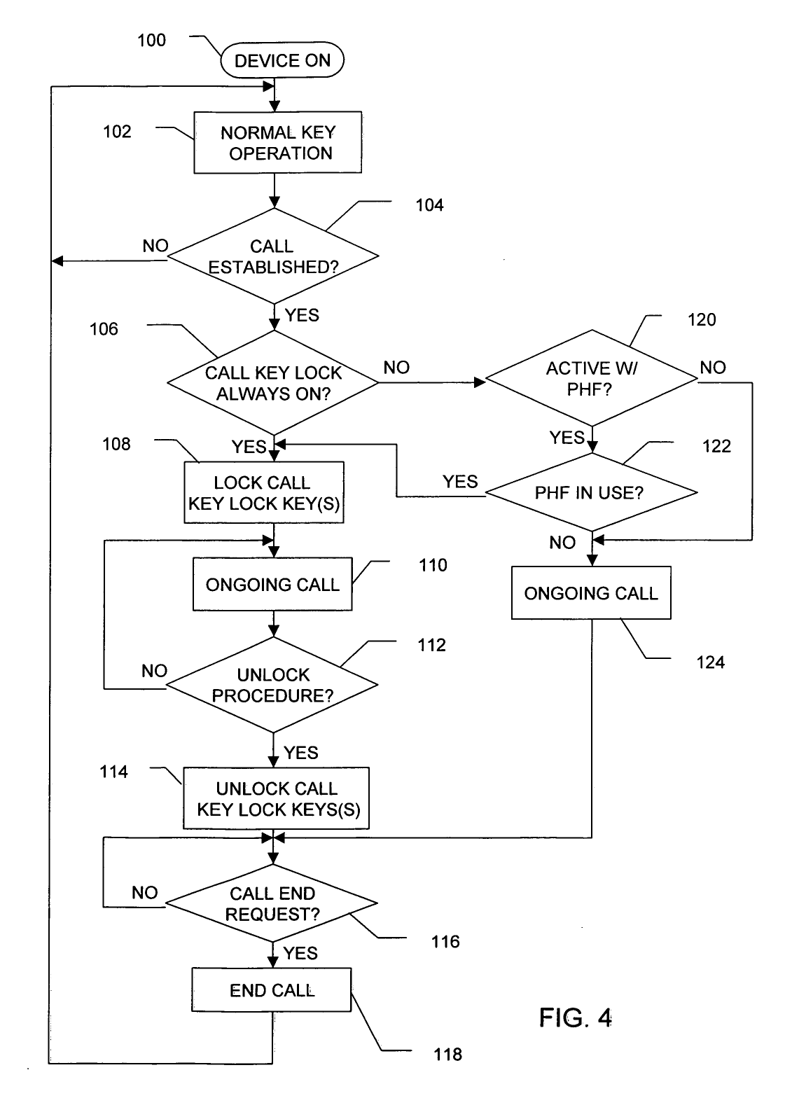

FIG. 2 represents a functional block diagram of the mobile phone 10. With the exception of the key lock circuitry according to the present invention, which is preferably implemented via application software within the mobile phone 10, the construction of the mobile phone 10 is otherwise generally conventional as will be appreciated. The mobile phone 10 includes a primary control circuit 40 that is configured to carry out overall control of the functions and operations of the mobile phone 10. The control circuit 40 may include a CPU, microcontroller, or microprocessor, etc., collectively referred to herein simply as a CPU 42. The CPU 42 executes code stored in memory within the control circuit 40 (not shown) and/or in a separate memory 44 in order to carry out conventional operation of the mobile phone 10. In addition, however, the CPU 42 executes code stored in the memory 44 in accordance with the present invention in order to perform a call established detection function 46 and a key lock processing function 48. As is explained in more detail below with respect to FIG. 4, the call established detection function 46 is used within the mobile phone 10 to detect when a call has been established (e.g., “call connected”) with a called/calling device. In another embodiment, the call established detection function 46 also detects when a call has been disconnected (e.g., “call ended”). This can occur, for example, in the case where the called/calling device has hung up and the connection with the called/calling device has been terminated. As another example, this can occur when poor mobile reception at the mobile phone 10 or the called/calling device results in the connection being lost/terminated.

A person having ordinary skill in the art of computer programming and specifically in applications programming for mobile phones will consider it obvious in view of the description provided herein how to program a mobile phone 10 to operate and carry out the functions described herein. Accordingly, details as to the specific programming code have been left out for sake of brevity. Also, while the call established detection function 46 and key lock processing function 48 are carried out via the CPU 42 and application software in the memory 44 in accordance with the preferred embodiment of the invention, such functions could also be carried out via dedicated hardware, firmware, software, or combinations thereof, without departing from the scope of the invention. “Key lock circuitry”, as referred to herein, is intended to encompass any and all such variations.

Continuing to refer to FIG. 2, the mobile phone 10 includes an antenna 50 coupled to a radio circuit 52. The radio circuit 52 includes a radio frequency transmitter and receiver for transmitting and receiving signals via the antenna 50 as is conventional. The mobile phone 10 further includes a sound processing circuit 54 for processing the audio signal transmitted by/received from the radio circuit 52. Coupled to the sound processing circuit 54 are a speaker 56 and microphone 58 which enable a user to listen and speak via the mobile phone 10 as is conventional. The radio circuit 52 and sound processing circuit 54 are each coupled to the control circuit 40 so as to carry out overall operation.

The mobile phone 10 also includes the aforementioned display 14 and keypad 16 coupled to the control circuit 40. In the case where all or part of the display 14 comprises a touchscreen, such operation may be represented by the touchscreen 14a in FIG. 2. The mobile phone 10 further includes an I/O interface 60. The I/O interface 60 may be in the form of typical mobile phone I/O interfaces, such as a multi-element connector at the base of the mobile phone 10. As is typical, the I/O interface 60 may be used to couple the mobile phone 10 to a battery charger to charge a power supply unit 62 within the mobile phone 10. In addition, or in the alternative, the I/O interface 60 may serve to connect the mobile phone 10 to a wired personal hands-free adaptor (not shown) or Bluetooth adaptor (also not shown) for use with a Bluetooth-based hands-free adaptor. Further, the I/O interface 60 may serve to connect the mobile phone 10 to a personal computer or other device via a data cable, etc.

The I/O interface 60 is not necessary to the fundamental aspects of the present invention, and nor are the particular functions of the I/O interface 60 necessarily germane to the invention. On the other hand, according to one particular aspect of the invention, the control circuit 40 is configured to detect automatically when a wired or wireless (e.g., Bluetooth) personal hands-free adaptor is coupled to the mobile phone 10. This may be via mechanical contact, device ID detection, etc. Such feature is known in mobile phones. However, as described in more detail below, the present invention makes use of such feature as part of its key lock protection.

The mobile phone 10 may also include a timer 64 for carrying out timing functions. Such functions may include timing the durations of calls, etc. In addition, however, the timer 64 may serve to detect such things as the time during which a key or keys are activated by a user as will be explained in more detail below.

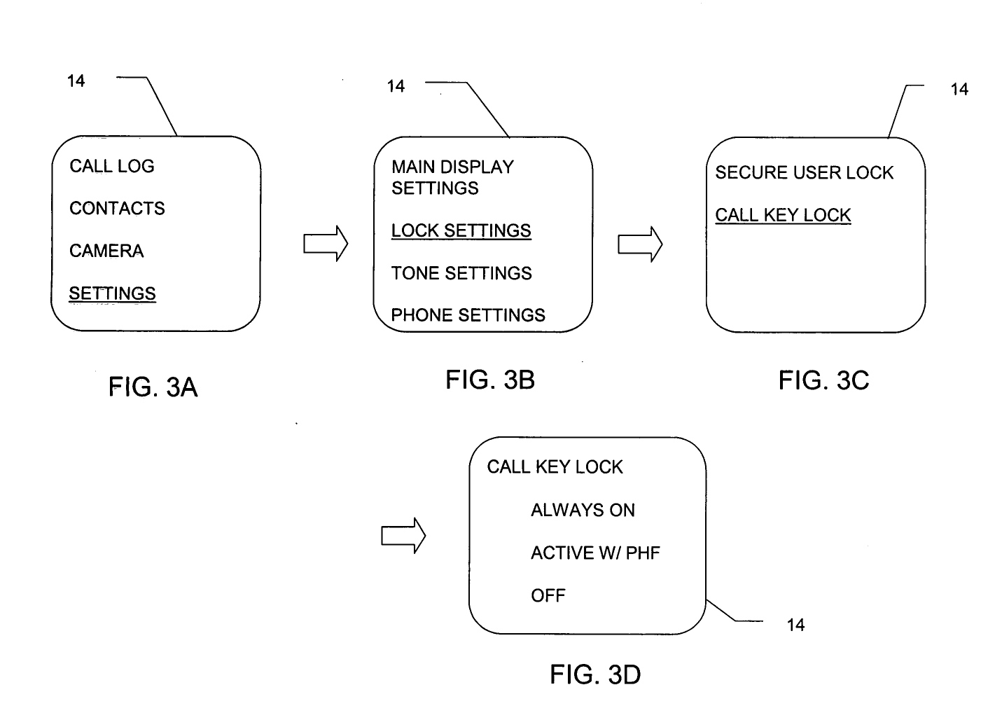

Turning now to FIGS. 3A-3D, exemplary screen displays are shown illustrating a manner in which a user may initiate the key lock features of the present invention. Using the navigation keys 22a, 22b and 22c on the keypad 16, for example, the user may call up a main menu on the display 14 as shown in FIG. 3A. By manipulating the navigation keys, the user may select “Settings” leading to the sub-menu shown in FIG. 3B. Again, by manipulating the navigation keys the user may then select “Lock Settings” resulting in the sub-menu shown in FIG. 3C. By selecting “Call Key Lock” in the menu of FIG. 3C, the user may thereby initiate the features of the present invention.

Specifically, the user may select in the menu of FIG. 3D whether the key lock processing is “Always On”, “Active w/ PHF”, or “Off”. “Active w/ PHF” refers to the key lock processing being active only when the mobile phone 10 is used in personal hands free operation. Such operation may be detected via the I/O interface 60 as described above when a wired or wireless personal hands free adaptor is connected to the mobile phone 10. In addition, or in the alternative, the mobile phone 10 may detect personal hands free operation by virtue of the user having turned on “speakerphone” operation which has become increasingly common in mobile phones. By selecting either “Always On”, “Active w/ PHF”, or “Off”, the user may control how the mobile phone 10 functions with respect to key lock processing as will now be described in detail with respect to FIG. 4.

Referring now to FIG. 4, a flowchart is shown that illustrates the operation of the mobile phone 10 with respect to key lock processing in accordance with the present invention. Operation begins in Step 100 where the mobile phone 10 has been turned on, e.g., via the power on/off key 28 (FIG. 1). Following Step 100, the mobile phone 10 proceeds to Step 102 in which the phone 10 exhibits normal button operation, i.e., the keys on the keypad 16 and/or touchscreen 14 are all enabled. This represents the mobile phone's “normally unlocked” operation, meaning even if the user has selected key lock processing to be “Always On” or “Active w/ PHF”, the keys on the mobile phone 10 remain active while the mobile phone 10 is not engaged in a call. In another embodiment, however, Step 102 may be replaced with a step of “normally locked”. In such an embodiment, the user must first unlock the mobile phone via a predefined “unlock sequence” such as described in more detail below in order to make or receive a call.

Following Step 104, the mobile phone 10 in Step 104 determines if a call has been established with a called/calling device. Such determination can be carried out using the call established detection function 46 described above with respect to FIG. 2. Known existing technology in mobile phones enables the mobile phones to detect when a call connection has been made with a called/calling device so as to represent an established call, and to detect when a call connection has been ended by virtue of a party ending the call (hanging up) or by loss of the connection due to a weak signal, etc.

If in Step 104 a call has not been established by virtue of the user making a call or receiving a call via the mobile phone 10, control of the mobile phone 10 continues to loop through Steps 102 and 104 as illustrated in FIG. 4. On the other hand, if a call has been established as determined in Step 104 the mobile phone 10 proceeds to Step 106. In Step 106, the control circuit 40 via the lock processing function 48 (FIG. 2) determines if the key lock processing is “Always On” as decided by user selection such as via the menu screen in FIG. 3D. If the user has selected for the key lock processing to be “Always On” as decided in Step 106, the key lock processing function 48 of the mobile phone 10 proceeds to step 108 where the key lock processing function 48 automatically disables one or more keys on the keypad 16 and/or touchscreen 14. In the preferred embodiment, the key or keys automatically disabled in Step 108 include the “call end” key 20. By “disabled”, it is referred to herein that the key or keys no longer operate to provide their normal function. Thus, if the “call end” key 20 is inadvertently activated by the user, the “call end” key 20 will not function to end the call determined to be established in Step 104. This can be easily accomplished, for example, by causing the control circuit 40 to execute modified code when the key lock processing is active so as not to recognize inadvertent activation of the “call end” key 20.

In addition, or in the alternative, keys other than the “call end” key 20 may be similarly automatically disabled in Step 108. For example, the key lock processing function 48 may be configured to disable automatically other keys that may undesirably end or disrupt the established call (e.g., power on/off key 28, “mute” key 26, or other predefined keys) without departing from the scope of the invention. By “automatically” disabling or locking such keys as referred to herein with respect to Step 108, it is referred to herein that no active or conscious step is required by the user in order to disable or “lock” the keys. The keys become locked without requiring specific effort on the part of the user.

Furthermore, in a preferred embodiment of the invention one or more other keys on the keypad 16 and/or touchscreen 14 are purposely not disabled or “locked” in Step 108. For example, the key lock processing function 48 (FIG. 2) preferably is configured not to disable one or more other keys predefined not to disrupt or end an established call. Such keys may include, but are not limited to, the alphanumeric keys, the volume key 24, the web browser launch key 30, etc. This way, the present invention allows keys such as the “call end” key, “mute” key, etc., which may disrupt or end an established call, to be disabled; while keys such as the alphanumeric keys, volume key, web browser launch key, etc. may remain enabled. This allows the user to enter information, adjust the volume, launch the web browser, etc., via the mobile phone 10 without first having to execute a predefined unlock procedure, yet still retain protection against undesired disruption or ending of the call.

Following Step 108, the mobile phone 10 proceeds to Step 110 which represents the ongoing nature of the established call. Next, in Step 112, the lock processing function 48 (FIG. 2) determines if the user has input an unlock procedure. The unlock procedure can be any predefined procedure, but preferably one that is highly unlikely to occur as a result of inadvertent activation of one or more keys on the keypad 16 and/or touchscreen 14. For example, the control circuit 40 may be configured to recognize if an otherwise disabled key such as the “call end” key 20 is activated continuously by the user for longer than a predetermined time (e.g., 5 seconds). Such determination can be made using the timer 64, for example. Alternatively, the unlock procedure in step 112 may be represented by a predefined sequence of keys such as a numeric code (e.g., 1-2-3) entered via the alphanumeric keys. Such unlock procedure in Step 112 may include keys which are otherwise enabled or disabled via step 108, so long as the unlock procedure is not likely to result as a result of inadvertent or accidental activation. Again, the particular unlock procedure is not germane to the broadest aspects of the present invention.

In the embodiment of FIG. 4, if the lock processing function 48 detects the unlock procedure in Step 112 the mobile phone 10 proceeds to Step 114. In Step 114, the lock processing function 48 proceeds to reenable or “unlock” the one or more keys that were locked previously in Step 108. In this sense, the mobile phone 10 returns to normal key operation. If in Step 112 the lock processing function 48 does not detect the unlock procedure, the process loops back to step 110 and the established call continues with the one or more keys disabled in Step 108 remaining disabled so as to avoid inadvertent activation.

Following Step 114, the mobile phone 10 proceeds to Step 116 in which the control circuit 40 determines whether a “call end” request has been received via activation of the “call end” key 20. If no, the mobile phone continues to loop thru Step 116. On the other hand, if yes in Step 116, indicating that the user wishes to end the call, the control circuit 40 proceeds to step 118 in which the call is disconnected or ended in conventional manner. Following Step 118, control circuit 40 returns to Step 102 and the above-described process is repeated.

Returning briefly to Step 106, if the control circuit 40 (FIG. 2) determines that the user has not selected for the lock key processing to be “Always On”, the control circuit 40 proceeds to Step 120. It is in Step 120 that the control circuit 40 determines if the user instead selected that the lock key processing be “Active w/ PHF” via the menu in FIG. 3D, for example. If yes, the control circuit 40 proceeds to Step 122 in which it determines whether personal hands free operation is in use. As discussed above, this may be determined by virtue of the mobile phone 10 detecting whether a wired or wireless personal hands free adaptor has been connected to the I/O interface 60 (FIG. 3). Alternatively, the control circuit 40 may detect such operation based on the mobile phone 10 having been placed in a “speakerphone” mode. Provided personal hands free operation is in use as determined in Step 122, the mobile phone 10 proceeds to Step 108 as shown. Step 108 and subsequent steps are then carried out as previously explained.

If in Step 122 the control circuit 40 determines that hands free operation is not in use, e.g., by the absence of a hands free adaptor connected to the I/O interface 60 or the mobile phone 10 not being in a “speakerphone” mode, the mobile phone 10 proceeds to step 124. Step 124 represents operation of the mobile phone 10 engaged in an established call without the key lock processing of the present invention being active. The mobile phone then proceeds to Step 116 where it remains engaged in the call until a “call end” request is received as explained above. Similarly, if in Step 120 the lock processing function 48 determines that the user has not selected “Active w/ PHF”, it is inferred that the user has selected that the lock processing feature is “Off” as represented in FIG. 3D. Thus, in such case the mobile phone 10 in Step 120 proceeds directly to Step 124 and on to Step 116 as shown in FIG. 4.

The embodiment shown in FIG. 4 requires that the user execute the unlocking of the one or more keys (Step 112) and execute a call end request (116) to end the call fully. In an alternative embodiment, the process defined in FIG. 4 is modified to include a decision step in between Steps 110 and 112. Specifically, in between Steps 110 and 112 the control circuit 40 determines if the established call has been disconnected. This may be a result of the called/calling device intentionally ending the call by “hanging up”, or by a loss of connection due to poor reception by the mobile phone 10 and/or the called/calling device. The radio circuit 52 in combination with the control circuit 40 are conventionally designed to detect the disconnection in either case. If in between Steps 110 and 112 the control circuit 40 detects that the established call has been disconnected and therefore is no longer ongoing, the process automatically reenables or unlocks any keys locked in Step 108, and branches directly to Step 118 where automatically the call is fully ended. In this manner, it is not necessary for the user to execute the unlocking of Step 112 and call end request of Step 116. Rather, the mobile phone 110 will return automatically to normal operation in Step 102 following Step 118 simply as a result of the user waiting for the called/calling device to “hang up” or the connection to otherwise become disconnected.

Of course, if in between Steps 110 and 112 the control circuit 40 does not detect that the established call has been disconnected, the process will continue to loop through the intermediate step together with Steps 110 and 112 as will be appreciated.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An electronic equipment, comprising:
one or more keys which enable a user to control operation of the electronic equipment;
call circuitry that enables the electronic equipment to establish a call with a called/calling device; and
key lock circuitry which, upon detecting that the call circuitry has established a call, automatically disables at least one of the one or more keys.

2. An electronic equipment according to claim 1, wherein the at least one of the one or more keys comprises a key which, if not disabled, would at least one of disrupt or end the established call if activated.

3. An electronic equipment according to claim 2, wherein the at least one of the one or more keys comprises a call end key.

4. An electronic equipment according to claim 2, wherein the at least one of the one or more keys comprises a key which, if not disabled, would cause an audible disruption if activated.

5. An electronic equipment according to claim 4, wherein the at least one of the one or more keys comprises an audio mute key.

6. An electronic equipment according to claim 2, wherein the key lock circuitry automatically disables the at least one key which would at least one of disrupt or end the established call, but does not disable one or more other keys.

7. An electronic equipment according to claim 6, wherein the one or more other keys comprise at least one of a volume key, web browse launch key, camera key or data input key.

8. An electronic equipment according to claim 1, wherein the one or more keys are embodied in at least one of a keypad or a touchscreen.

9. An electronic equipment according to claim 1, wherein the user may selectively cause the key lock circuitry to reenable the at least one of the one or more keys during the established call.

10. An electronic equipment according to claim 9, wherein the user may selectively cause the key lock circuitry to reenable the at least one of the one or more keys by pressing a predefined key among the one or more keys for at least a predetermined time.

11. An electronic equipment according to claim 10, wherein the predefined key is a call end key.

12. An electronic equipment according to claim 1, wherein the key lock circuitry detects when the call has been ended other than by the user, and upon detecting that the call has been ended other than by the user automatically reenables the at least one of the one or more keys.

13. An electronic equipment according to claim 1, wherein the electronic equipment is a mobile phone.

14. An electronic equipment according to claim 13, wherein the key lock circuitry may be selectively enabled by the user via a user interface.

15. An electronic equipment according to claim 14, wherein the user may selectively enable the key lock circuitry among an always on mode, always off mode, and hands-free mode.

16. A program stored on a machine readable medium, the program being suitable for use in an electronic equipment having one or more keys which enable a user to control operation of the electronic equipment and call circuitry that enables the electronic equipment to establish a call with a called/calling device, wherein:
when the program is loaded in memory in the electronic equipment and executed, causes the electronic equipment, upon detecting that a call has been established, to disable automatically at least one of the one or more keys.

17. A program according to claim 16, wherein the at least one of the one or more keys comprises a key which, if not disabled, would at least one of disrupt or end the established call if activated.

18. A program according to claim 17, wherein the at least one of the one or more keys comprises a call end key.

19. A program according to claim 17, wherein the at least one of the one or more keys comprises a key which, if not disabled, would cause an audible disruption if activated.

20. A program according to claim 19, wherein the at least one of the one or more keys comprises an audio mute key.

21. A program according to claim 16, wherein the program causes the electronic equipment to detect when the call has been ended other than by the user, and upon detecting that the call has been ended other than by the user, automatically to reenable the at least one of the one or more keys.

22. A program according to claim 16, wherein the program is designed for the electronic equipment to be a mobile phone.
